(19) United States
(12) Patent Application Publication
(10) Pub. No.: US 2017/0234044 A1
(43) Pub. Date: Aug. 17, 2017

(54) Security Door Stop

(71) Applicant: Aaron Everett Schwan, Colorado Springs, CO (US)

(72) Inventor: Aaron Everett Schwan, Colorado Springs, CO (US)

(21) Appl. No.: 15/044,058

(22) Filed: Feb. 15, 2016

(51) Int. Cl. E05C 17/54; E05B 17/20

(52) U.S. Cl. CPC E05C 17/54; E05B 17/2084

(57) ABSTRACT

Wood or metal wedge with metal plate attached to bottom by two or more screws. Front extends beyond wedge to allow it to slide beneath even tightly fit doors. Base plates are interchangeable to accommodate different floor surfaces. Metal base has two or more rows of triangular spikes designed to specifically engage with various types of carpet commonly found in commercial office buildings. The spikes are fine enough to engage the carpet regardless of the direction of the pile, yet sturdy enough to withstand repeated attempts to force door open. There is an optional handle that can be screwed into the back of the wedge.

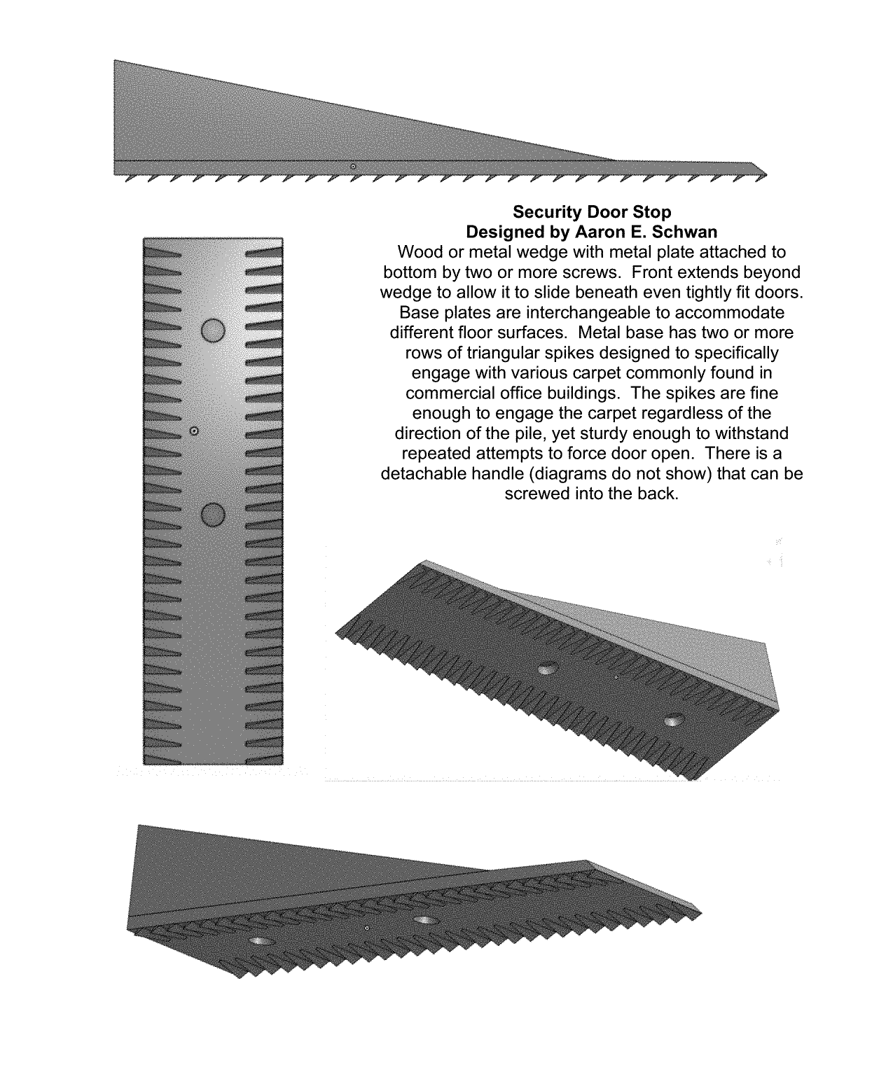

Wood or metal wedge with metal plate attached to bottom by two or more screws.

Front extends beyond wedge to allow it to slide beneath even tightly fit doors. Base plates are interchangeable to accommodate different floor surfaces. Metal base has two or more rows of triangular spikes designed to specifically engage with various types of carpet commonly found in commercial office buildings. The spikes are fine enough to engage the carpet regardless of the direction of the pile, yet sturdy enough to withstand repeated attempts to force door open. There is an optional handle that can be screwed into the back of the wedge.

1. A wedge-shaped piece of wood or metal wedge with a metal plate attached to bottom by two or more screws.
(a) Front extends beyond wedge to allow it to slide beneath even tightly fit doors.
(b) Base plates are interchangeable to accommodate different floor surfaces.
(c) Metal base has two or more rows of triangular spikes designed to specifically engage with various types of carpet commonly found in commercial office buildings. The spikes are fine enough to engage the carpet regardless of the direction of the pile, yet sturdy enough to withstand repeated attempts to force door open.
(d) There is an optional handle that can be screwed into the back of the wedge.
Whereby said doorstop can slow or inhibit free access through a door when the device is engaged.
